(19) United States
(12) Patent Application Publication
(10) Pub. No.: US 2009/0040900 A1
(43) Pub. Date: Feb. 12, 2009

(54) Pasting method of non-insulation sheet upon printed circuit board, as well as, printed circuit board and optical disk apparatus

(76) Inventors: Masahiro Takasago, Kawasaki (JP); Shigehiko Takeshita, Funabashi (JP); Mitsuo Kurokawa, Fujisawa (JP); Goshi Shiroishi, Tokyo (JP); Koichi Ihara, Yokohama (JP)

Correspondence Address: MCDERMOTT WILL & EMERY LLP, 600 13TH STREET, N.W., WASHINGTON, DC, 20005-3096, US

(21) Appl. No.: 12/071,689

(22) Filed: Feb. 25, 2008

(30) Foreign Application Priority Data
Aug. 7, 2007 (JP) 2007-205403

(51) Int. Cl. G11B 7/00; B32B 3/00; B32B 37/12

(52) U.S. Cl. 369/100; 156/60; 428/201

(57) ABSTRACT

A pasting method for pasting a non-insulation sheet 20 on a printed circuit board 10, for pasting the non-insulation sheet 20 for shielding electromagnetic waves upon a surface of the printed circuit board 10, which comprises a pattern land formed on an insulation board for soldering a part thereon and a solder resist layer covering a part on the pattern land by a solder resist, comprising the following steps of: a step of forming a ring-like insulation layer 30 for adhering an end face of the non-insulation sheet 20, upon the solder resist layer; and a step for adhering the end face of the non-insulation sheet 20 onto the insulation layer 30, wherein the insulation layer 30 is formed so that the end face of the non-insulation sheet 20 lies within a predetermined region of the insulation layer 30, and thereby providing the method for enabling to paste the non-insulation sheet onto the printed circuit board, during the manufacturing process of the printed circuit board, but without necessity of putting the insulation sheet between the non-insulation sheet and the printed circuit board.

### BACKGROUND OF THE INVENTION

The present invention relates to a pasting method of a non-insulation sheet onto a printed circuit board, i.e., for pasting the non-insulation sheet in use of shielding radio wave (or electromagnetic waves) upon the printed circuit board, effectively, and further it also relates to a printed circuit board pasted or stuck with said non-insulation sheet thereon, and an optical disk apparatus of using it therein, as well.

Conventionally, the non-insulation sheet, such as, an EMI (ElectroMagnetic Inference) sheet is used, for the purpose of preventing the electromagnetic waves from giving ill influences upon other electronic equipments, by reducing the electromagnetic waves generating from electronic parts, which are installed within an electronic equipment, etc., and/or also protecting the electronic equipment from malfunction thereof, due to the ill influences given by the electromagnetic waves from an outside.

For example, the following Patent Document 1 disclosed the technology of an electromagnetic wave shield film therein, having a base made of a resin, a metal layer piled upon on an upper surface of this base film, and a protection file made of a resin, being pile up on an upper surface of this metal layer, wherein an end or edge of this protection film extends into an outside of the end of the base film mentioned above, thereby enabling to deal with a case when a portion is small where the sheet should be provided, and thereby preventing from short-circuiting thereof.

Also, the following Patent Document 2 discloses therein an electromagnetic wave shield film and a manufacturing method thereof, which comprises a transparent base film, a transparent layer of conductive material having an electrode portion, which is provided at least a part of an outer peripheral portion thereof, and a layer of an adhesive or a gluing agent, being so provided that it covers the surface of the transparent layer of the conductive material, but not facing to that transparent base film, including the electrode portion therein, wherein the layer covering over the electrode portion is pushed away, with pressure applied thereon when it is attached, to be conductive with a grounding electrode facing thereto, thereby achieving the grounding with ease.

[Patent Document 1] Japanese Patent Laying-Open No. 2006-135020 (2006); and

[Patent Document 2] Japanese Patent Laying-Open No. 2006-196760 (2006).

### BRIEF SUMMARY OF THE INVENTION

However, in case when sticking or pasting the electromagnetic wave shield film described in the Patent Document 1 or 2 onto a printed circuit board, it is further necessary to put the insulation sheet between the printed circuit board and that electromagnetic wave shield film, for the purpose of ensuring or maintaining an insulation between the printed circuit board. This is because, although the insulation can be ensured with provision of a solder resist on the printed circuit board, but since the thickness of that solder resist is thin, then the conductive portion is bared or exposed due to scratch or the like; i.e., there is a possibility of short-circuiting and/or breaking of wires. Further, because of putting the insulation sheet between them, there is a problem that an effect of electromagnetic wave shielding due to the electromagnetic wave shield film is reduced, comparing to the case of directly pasting that electromagnetic wave shield film on the solder resist.

By taking the problems mentioned above into the consideration thereof, an object is, according to the present invention, to provide a pasting method of a non-insulation sheet onto a printed circuit board, for enabling to paste the non-insulation sheet onto the printed circuit board, during the manufacturing process of the printed circuit board, but without necessity of putting the insulation sheet between the non-insulation sheet and the printed circuit board.

Also, another object is, according to the present invention, to provide a cheap printed circuit board for shielding the electromagnetic waves, effectively, with applying the pasting method mentioned above therein.

Further other object is, according to the present invention, to provide an optical disk apparatus for lowering the malfunctions thereof by installing the printed circuit board mentioned above into the optical disk apparatus, and also thereby to reduce unnecessary radiation of the electromagnetic waves into an outside thereof.

For dissolving such the drawbacks as mentioned above, according to the present invention, there is provided a pasting method for pasting a non-insulation sheet on a printed circuit board, for pasting the non-insulation sheet for shielding electromagnetic waves upon a surface of said printed circuit board, which comprises a pattern land formed on an insulation board for soldering a part thereon and a solder resist layer covering a part on said pattern land by a solder resist, comprising the following steps of: a step of forming a ring-like insulation layer for adhering an end face of said non-insulation sheet, upon said solder resist layer; and a step for adhering the end face of said non-insulation sheet onto said insulation layer, wherein said insulation layer is formed so that the end face of said non-insulation sheet lies within a predetermined region of said insulation layer.

In this manner, adhering the end face of the non-insulation sheet within the predetermined region of the insulation layer enables to fix a cutting face of the non-insulation sheet, upon which no insulation process is treated, on the insulation layer, easily and also effectively, and thereby protecting the printed circuit board from being damaged by the said cutting face.

Also, the pasting method for pasting a non-insulation sheet on a printed circuit board, according to the present invention, wherein said insulation layer is formed through a silk-screen printing; and the predetermined region of said insulation layer is within 2-4 mm of distance between an outer end and an inner end of said insulation layer.

In this manner, it is possible to apply the existing process for manufacturing the printed circuit board, and further to paste the non-insulation sheet on the printed circuit board, easily and also effectively.

Also, it is possible to provide the printed circuit board manufactured with applying the pasting method of the non-insulation sheet onto the printed circuit board mentioned above.

And, it is also possible to provide an optical disk apparatus applying such the printed circuit board as mentioned above therein.

According to the present invention, since the existing process for manufacturing the printed circuit board can be applied therein, it is possible to provide the pasting method for pasting the non-insulation sheet on the printed circuit board, easily and also effectively.

Also, applying the pasting method mentioned above therein, it is possible to provide the printed circuit board, cheaply, for shielding the electromagnetic waves, effectively.

And also, with installation of the printed circuit board mentioned above into the optical disk apparatus, it is possible to provide an optical disk apparatus for reducing malfunctions thereof, and also reducing unnecessary radiation of the electromagnetic waves into an outside.

### BRIEF DESCRIPTION OF THE DRAWINGS

Those and other objects, features and advantages of the present invention will become more readily apparent from the following detailed description when taken in conjunction with the accompanying drawings wherein:

FIG. 1 is a view for explaining a pasting method for pasting a non-insulation sheet onto a printed circuit board, according to an embodiment of the present invention;

FIG. 2 is a cross-section view of an EMI sheet, being the non-insulation sheet;

FIG. 3 is a cross-section view for showing the printed circuit board and the above-mentioned non-insulation sheet, upon which a silk-screen printing is made, and the EMI sheet;

FIG. 4 is a cross-section view for showing the printed circuit board, upon which the above-mentioned EMI sheet is pasted;

FIG. 5 is an outer perspective view for showing a personal computer mounting an optical disk apparatus, according to the present invention; and

FIG. 6 is an exploded perspective view for showing the inner structures of the optical disk apparatus mentioned above.

### DESCRIPTION OF THE PREFERRED EMBODIMENTS

Hereinafter, embodiments according to the present invention will be fully explained by referring to the attached drawings.

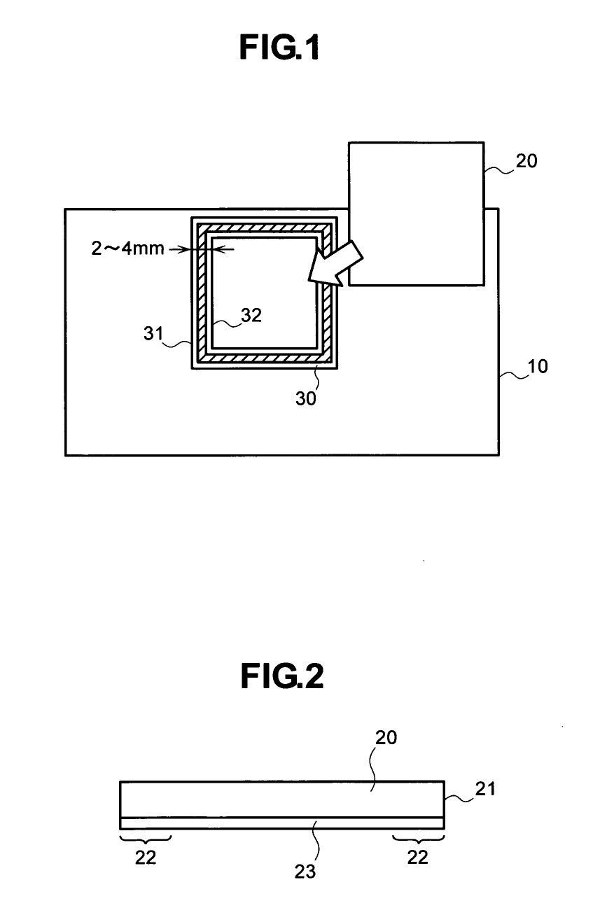

FIG. 1 attached herewith is a view for explaining a pasting method for pasting a non-insulation sheet onto a printed circuit board, according to an embodiment of the present invention. The printed circuit board 10 shown in FIG. 1 shows a surface, on which electronic parts are mounted, and shows a surface, on which the non-insulation sheet (hereinafter, being called “EMI sheet”) is pasted. As is shown in this FIG. 1, upon the printed circuit board 10, a silk-screen printing is treated in an area or region 30 where the EMI sheet 20 will be pasted is conducted, in a ring-like manner. The area 30 where the silk-screen printing is treated is a range surrounded by an outer frame 31 and an inner frame 32, in a frame-like manner, and thereby building up insulation layers.

FIG. 2 attached herewith shows the cross-section view of the EMI sheet mentioned above. The outer frame 31 of the silk-screen printing shown in FIG. 1 is so positioned that, when pasting the EMI sheet 20 on the region 30 mentioned above, the cut surface 21 of the EMI sheet 20 comes to be a little bit larger than the outer periphery of the EMI sheet 20, but not coming out from an outer end 31 thereof. An inner end 32 of the silk-screen printing is located at the position inside from the outer end 31 by 2-4 mm. When bonding the EMI sheet 20, end faces 22 of the EMI sheet are adhered within an area of width (2-4 mm) between the outer end 31 and the inner end 32 of the silk-screen printing, i.e., the area shown by slanting lines. Herein, the end surface 22 means a part of the end of the EMI sheet 20 that should be pasted within the region shown by slanting lines.

The EMI sheet 20 is used for the purpose of shielding the electromagnetic waves generating from the electronic parts, as was mentioned above, and it is made of a conductive material. The material of the EMI sheet 20 is, for example, metal powder (Fe, Si, Al, etc.) and chlorinated polyethylene or the like for use of hardening or tightening thereof.

On one surface of the EMI sheet 20 is pasted with an adhesive tape 23 to be stuck or pasted on the printed circuit board 10. The adhesive tape 23 is made by applying an adhesive or a tackiness agent on both sides of a polyester film, and on one surface thereof is stuck onto the EMI sheet 20 while the other surface thereof is stuck onto the printed circuit board 10. As the adhesive or the tackiness agent of the adhesive tape 23 is used that of an acryl group, for example.

The reason of making the cutting face 21 of the EMI sheet 20 not coming out the outer frame 31 of the silk-screen printing is to prevent the solder resist or the like from being scratched by the cutting face 21, upon which an insulation process is not treated with, i.e., for the purpose of protecting the printed circuit board 10 from being damaged, as a reason of short-circuiting and/or breaking of wires. Thus, sticking or pasting the end faces 22 of the EMI sheet 20 upon the area 30, where the silk-screen printing is treated, i.e., on the insulation layer, enables to fix the cutting face 21 of the EMI sheet 20, and thereby protecting it from such the damage as was mentioned above.

Also, since existing silk-screen printing process, which was applied within the manufacturing processes of the printed circuit board, can be used to be the process for the silk-screen printing, as it is, then no additional material nor work is generated therein. Also, because the silk-screen printing is a sort of the screen printings, therefore it is possible to determine the position, in advance, where the printing should be conducted, with correctness. For this reason, it is possible to determine the position where the silk-screen printing is made, by taking shift or deviation in the position of the EMI sheet 20 into the consideration, when pasting the EMI sheet 20 onto the printed circuit board 10. Further, it is also possible to determine the range, i.e., the region 30 of the silk-screen printing, so that the end face 22 of the EMI sheet 20 will not come out the region 30 of the silk-screen printing.

However, it is possible to determined the configuration of the region where the silk-screen printing should be made, other than the frame-like one mentioned above, for example, a circle, a polygon, etc., fitting to the various configurations of the EMI sheet.

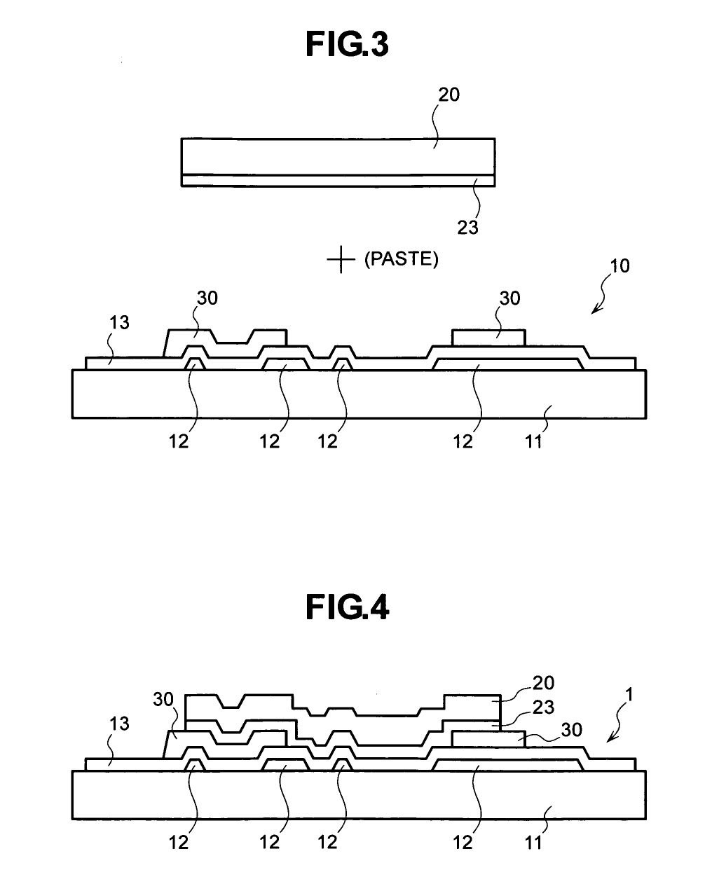

FIG. 3 attached herewith is the cross-section view for showing the printed circuit board, on which the above-mentioned silk-screen printing is made, and the EMI sheet. As is shown in this FIG. 3, within the printed circuit board 10, on the insulation board 11 thereof are formed conductors 12 for the circuit wiring and patter lands (not shown in the figure) for soldering electronic parts thereon. In part of those conductors 12 and patter lands are formed a solder resist layer 13. However, though the solder resist layer 13 is an insulation layer, but the thickness thereof is thin, such as 20-30 μm, for example, and therefore, as was mentioned above, there is a possibility that the conductors 12 are bared or exposed through scratching by the cutting face 21 of the EMI sheet 20. For this reason, it is impossible to paste or stick the end faces 22 of the EMI sheet 20 on the solder resist layer 13, directly. Therefore, conventionally, upon the solder resist layer 13 is pasted the insulation sheet (not shown in the figure), and further on that, the EMI sheet 20 is pasted. For this reason, it is necessary to prepare an insulation sheet, separately, as a material, and there is also necessity of a process for pasting that insulation sheet within the manufacturing process of the printed circuit board. Furthermore, pasting of this insulation sheet reduces the effect of the EMI sheet 20, i.e., shielding the electromagnetic waves, comparing to the case where the EMI sheet is pasted directly on the solder resist layer.

Then, according to the present invention, for the purpose of protecting the insulation layer 13 made of the solder resist, as is shown in FIG. 3 mentioned above, an insulation layer 30 is formed on the solder resist layer 13, with using an ink for use of the silk-screen printing. In general, as a material for forming the insulation layer, which are included in the insulation ink to be printed, may be one that shows an electric insulation property, such as, an epoxy resin having a thermosetting or thermo-hardening property, for example.

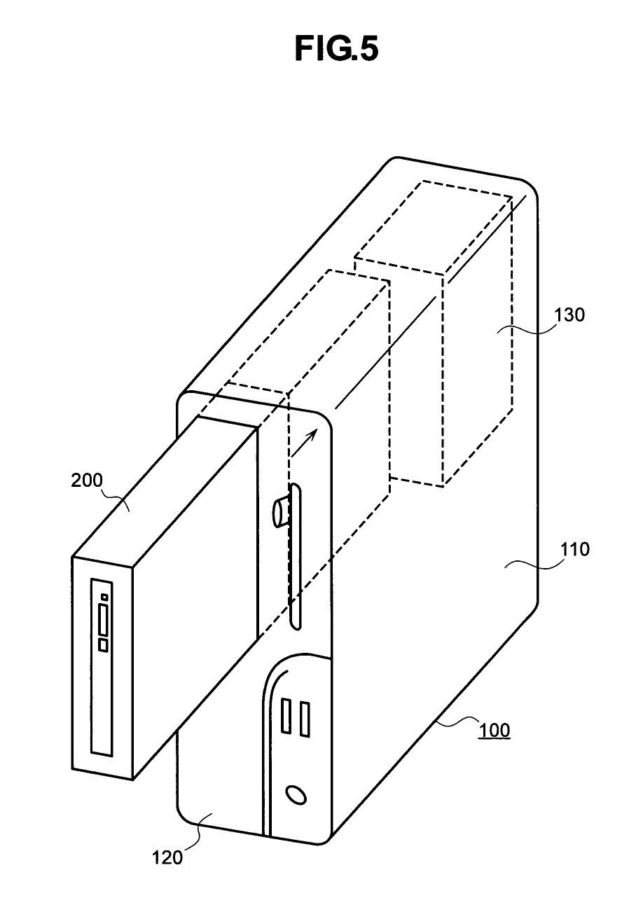

FIG. 4 is the cross-section view for showing the printed circuit board, upon which the above-mentioned EMI sheet is pasted. Thus, the printed circuit board 10 is obtained by pasting the EMI sheet 20 on the printed circuit board 10 with pressure thereon. Through the adhesive tape 23, the end faces 22 of the EMI sheet 20 is adhered within the range of the insulation layer 30, which is formed through the silk-screen printing, and portions other than the end faces 22 are adhered on the solder resist layer 13. Since the cut face 21 of the EMI sheet 20 is fixed on the insulation layer 30, which is formed through the silk-screen printing, in this manner, it is possible to prevent the solder resist layer 13 from being scratched by the cut face 21 of the EMI sheet 20, so that the conductors 12 are bared or exposed. Further, since it is enough that an area of the region of the insulation layer by the silk-screen printing is small, by far, comparing to the area of the conventional insulation sheet, which is pasted separately, then this will not reduce the effect of shielding the electromagnetic waves.

However, although the printed circuit board 1 shown in FIG. 4 is built up with a single layer, but the present invention may be applied into a multi-layer printed circuit board, made up by putting a printed circuit between plural numbers of the insulation boards.

As was explained in the above, the pasting method for pasting the EMI sheet onto the printed circuit board, according to the present invention, enables to paste the EMI sheet 20 on the printed circuit board 10, effectively, and also easily, with applying the silk-screen printing within the existing manufacturing processes of the printed circuit board.

Also, since there is no necessity of putting the insulation sheet between the EMI sheet and the printed circuit board, as in the conventional art, therefore it is possible to increase the effect of shielding the electromagnetic waves, comparing to the case of putting the insulation sheet therebetween.

Further, the printed circuit board 1 pasted with the EMI sheet thereon, according to the present invention, which is manufactured in this manner, can be applied to be a printed circuit board of electronic equipment, to be stored within an inside of a personal computer, etc., for example, and is used for reducing the electromagnetic waves, thereby preventing the electronic equipment from giving ill influences onto other electronic equipments, and/or protecting that electronic equipment from being ill influenced by the electromagnetic waves from an outside.

FIG. 5 attached herewith shows an outlook of an optical disk apparatus 200 of a built-in type, i.e., an optical disk apparatus applying the printed circuit board according to the present invention therein, to be installed within a housing 110 of an electronic apparatus 100, such as, the personal computer, etc., for example, being attached such that a disk loading surface is exposed in a part of a front bezel of the said apparatus.

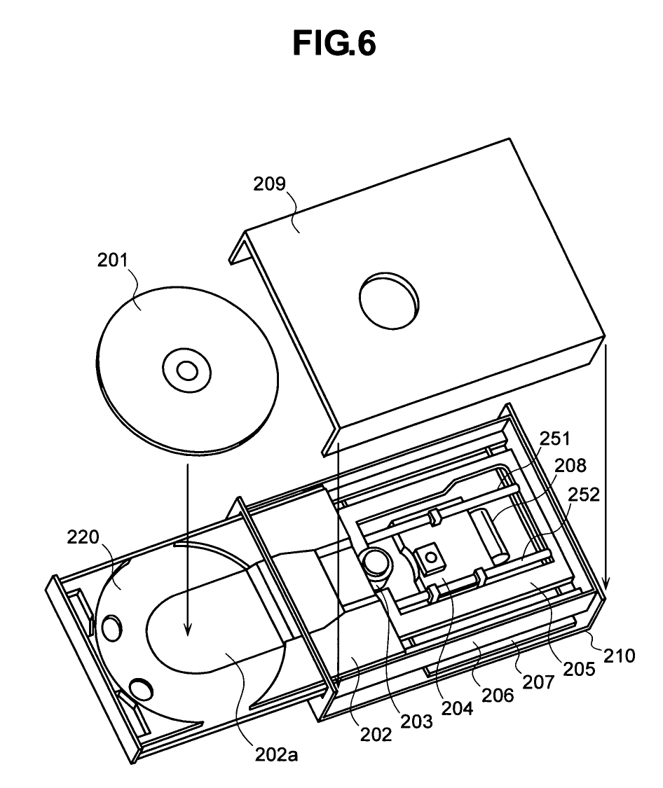

Following to the above, FIG. 6 attached herewith is an external view for shows the entire structures of the optical disk apparatus 200 of the built-in type mentioned above. In this FIG. 6, a reference numeral 201 depicts an optical disk, i.e., a disk-like recoding medium for optically recording information with an aid of the said optical disk apparatus, wherein the said optical disk 201 is loaded on a disk transfer member (i.e., a tray) 202 building up a part of the optical disk apparatus (i.e., on a disk loading plane portion 220), to be transferred into an inside of the apparatus. Further, at about the central portion of this disk transfer member (i.e., the tray) 202 is formed a first penetrating portion 202a, and below this is disposed a motor 203, i.e., a rotating device for rotationally driving the optical disk 201 mentioned above.

Also, in this figure, a reference numeral 204 depicts an optical pickup, 205 a unit mechanism chassis, including the optical pickup 204 mentioned above therein, 206 a unit chassis, including the unit mechanism chassis 205 mentioned above therein, and 207 the printed circuit board attaching various kinds of electronic parts thereon, according to the present invention, respectively. Further, as is apparent from the figure, between the optical pickup 204 and the printed circuit board 207 is attached a wide flexible cable (FFC) 208 for electrically connecting them. Also, a reference numeral 209 in the figure depicts a upper cover of the hosing of the optical disk apparatus, and 210 a lower cover of that housing.

However, the optical pickup 204 mentioned above builds therein lenses of an optic system and actuators for driving those, a detection circuit including a light receiving element, such as, a photo transistor, etc., for receiving a reflection laser beam, so as to convert it into an electric signal, a temperature detection means, and further a mechanism for exchanging a plural number of laser diodes, etc., as well as, the plural number of laser diodes, each having different wavelength, and driver circuits thereof (not shown in the figure).

Further, the optical pickup 204 mentioned above is attached to be movable along a pair of guide shafts (or, guide bars) 251 and 252, which are attached on the unit mechanism chassis 205 mentioned above, and is moved into a radial direction of the optical disk 201 loaded into the apparatus, by means of a moving mechanism including a motor for use of driving thereof (not shown in the figure).

Applying the printed circuit board, according to the present invention, into such the optical disk apparatus 200 mentioned above, it is possible to shield the electromagnetic waves, effectively, and thereby preventing the optical disk apparatus 200 from the malfunctions thereof, and/or preventing it from giving ill influences upon external electronic equipments.

However, it is needless to say that the printed circuit board pasting the EMI sheet thereon, according to the present invention, is shown to be the example, of being applied into the optical disk apparatus 200, but the said printed circuit board can be also applied into other electronic equipments, etc., which needs to shield the electromagnetic waves.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. A pasting method for pasting a non-insulation sheet on a printed circuit board, for pasting the non-insulation sheet for shielding electromagnetic waves upon a surface of said printed circuit board, which comprises a pattern land formed on an insulation board for soldering a part thereon and a solder resist layer covering a part on said pattern land by a solder resist, comprising the following steps of:
a step of forming a ring-like insulation layer for adhering an end face of said non-insulation sheet, upon said solder resist layer; and
a step for adhering the end face of said non-insulation sheet onto said insulation layer, wherein
said insulation layer is formed so that the end face of said non-insulation sheet lies within a predetermined region of said insulation layer.

2. The pasting method for pasting a non-insulation sheet on a printed circuit board, as described in the claim 1, wherein
said insulation layer is formed through a silk-screen printing; and
the predetermined region of said insulation layer is within 2-4 mm of distance between an outer end and an inner end of said insulation layer.

3. A printed circuit board, comprising:
an insulation board;
a pattern land formed on said insulation board for soldering a part thereon;
a solder resist layer covering a part on said pattern land by a solder resist; and
a non-insulation sheet for shielding electromagnetic waves, which is pasted on said printed circuit board, wherein
said insulation layer is formed so that the end face of said non-insulation sheet lies within a predetermined region of said insulation layer.

4. The printed circuit board, as described in the claim 3, wherein
said insulation layer is formed through a silk-screen printing; and
the predetermined region of said insulation layer is within 2-4 mm of distance between an outer end and an inner end of said insulation layer.

5. An optical disk apparatus, at least comprising:
a first driver portion, which is configured to drive an optical disk at a predetermined rotation speed;
an optical pickup portion, which is configured to irradiate a light beam from a semiconductor laser upon a recording surface of said optical disk rotationally driven by said first driving portion, so as to receive a reflection light from said recording surface, thereby to produce an electric signal;
a signal processor portion, which is configured to produce a desired signal upon basis of the electric signal produced within said optical pickup portion;
a second driver portion, which is configured to move said optical pickup portion into a radial direction of said optical disk; and
a controller portion for controlling each of said portions mentioned above upon basis of said electric signals produced, wherein said signal processor portion and said controller portion are disposed on a printed circuit board, and said printed circuit board comprises:
an insulation board;
a pattern land formed on said insulation board for soldering a part thereon;
a solder resist layer covering a part on said pattern land by a solder resist; and
a non-insulation sheet for shielding electromagnetic waves, which is pasted on said printed circuit board, wherein
said insulation layer is formed so that the end face of said non-insulation sheet lies within a predetermined region of said insulation layer.

6. The optical disk apparatus, as described in the claim 5, wherein
said insulation layer is formed through a silk-screen printing; and
the predetermined region of said insulation layer is within 2-4 mm of distance between an outer end and an inner end of said insulation layer.
